(19) United States
(12) Patent Application Publication
(10) Pub. No.: US 2014/0168763 A1
(43) Pub. Date: Jun. 19, 2014

(54) VARIABLE IMAGING SYSTEM WITH AN OBJECTIVE OF FIXED FOCAL LENGTH

(71) Applicant: Carl Zeiss Microscopy GmbH, Jena (DE)

(72) Inventor: Johannes Winterot, Jena (DE)

(73) Assignee: Carl Zeiss Microscopy GmbH, Jena (DE)

(21) Appl. No.: 14/105,897

(22) Filed: Dec. 13, 2013

(30) Foreign Application Priority Data
Dec. 19, 2012 (DE) 102012223712.7

(51) Int. Cl. G02B 21/02

(52) U.S. Cl. CPC G02B 21/025
USPC 359/380

(57) ABSTRACT

A variable imaging system which, starting from the object end, includes an objective of fixed focal length, at least one afocal zoom system, and a tube lens system. An afocal system of fixed magnification is arranged on the beam path between the objective and the afocal zoom system. The system includes means for axial displacement of the afocal system relative to the objective and to the zoom system, such that the position of the common back focal point of objective and afocal system is always set to the position of the entrance pupil of the zoom system, thus ensuring that object imaging is telecentric. The imaging system is suitable for use in microscopes. The invention can also be used to advantage in other optical systems employing tube lens systems of fixed or variable focal length.

### RELATED APPLICATIONS

This application claims priority to German National Application No. 102012223712.7, filed Dec. 19, 2012, said application being hereby fully incorporated herein by reference.

### FIELD OF THE INVENTION

The invention relates to a variable imaging system comprising (starting from the object side) an objective of fixed focal length, at least one afocal zoom system and a tube lens system. The invented imaging system is suitable, in particular, for use in microscopes, and, among these, preferably in low-power microscopes. The invention can also be used to advantage in other optical systems employing tube lens systems of fixed or variable focal length.

### BACKGROUND OF THE INVENTION

Imaging systems that are provided with afocal zoom systems and thus called variable are known per se. Generally, afocal zoom systems consist of at least three optical components, at least two of which are arranged to be movable along the optical axis for the purpose varying the magnification while maintaining the focusing, with the movements of the optical components being interdependent or tuned to each other.

With imaging systems of this kind one can set zoom positions for which the object-side imaging beam path is of telecentric configuration, resulting in telecentric imaging properties, which are of significant advantage for measurement applications, examination with coaxial reflected light and other applications. Many users, therefore, ask for imaging systems in which the image of the object to be examined is imaged in a telecentric mode in preferably all zoom positions that can be set.

In imaging systems known in prior art, afocal zoom systems are combined, e.g., with zoom objectives, i.e., objectives of variable effective focal length and back focal length. With constant back focal length, the effective focal length and the position of the back focal point of the zoom objective will vary. The total magnification of an imaging system comprising a zoom objective and an afocal zoom system results from the focal length of the tube lens system, the magnification set on the zoom system and the focal length set on the objective. The objective focal length is a function of the position of the entrance pupil of the afocal zoom system, and the position of the entrance pupil is a function of the respective zoom system, i.e. of the magnification set on the zoom system. Object imaging will be telecentric only if the back focal point of the zoom objective and the entrance pupil of the afocal zoom system share the same position on the beam path.

It follows from this that the imaging properties are influenced not only by the movement characteristic of the back focal point of the zoom objective but likewise also by the movement characteristic of the entrance pupil of the afocal zoom system. One can distinguish between afocal zoom systems in which the position of the entrance pupil varies with the magnification setting, and afocal zoom systems in which the entrance pupil has a fixed position independent of the magnification setting. The movement characteristic of the entrance pupil is determined by the position of the aperture diaphragm in the imaging system. The position of the entrance pupil is variable if the aperture diaphragm is positioned within the afocal zoom system and at least one of the optical components of the afocal zoom system that are movable along the optical axis is arranged between the objective and the aperture diaphragm. A fixed position of the entrance pupil is achieved if the aperture diaphragm is placed along the beam path in front of the movable optical components of the zoom system, or if the aperture diaphragm is projected, by means of the movable optical components of the zoom system, to a constant position at the entrance of the zoom system.

One problem in combining zoom objectives with afocal zoom systems is that decreasing magnifications of the zoom system result in increasing focal lengths of the zoom objective and, thus, a reduction of the total magnification range. If the setting of the zoom objective is coupled with that of the afocal zoom system, telecentric imaging is at best possible within a partial magnification range.

Other variable imaging systems are known in which afocal zoom systems in are used in combination with objectives featuring a fixed focal length and, thus, a fixed position of their back focal point, e.g., in the form of telecentric stereomicroscopes or low-power microscopes. It is this field of variable imaging systems incorporating an objective of fixed focal length and an afocal zoom system to which embodiments of the invention relates.

In this combination, too, imaging of the object is telecentric only if the position of the entrance pupil of the zoom system coincides with the position of the back focal point of the objective.

On the one hand, objectives of fixed focal length are used together with afocal zoom systems in which the position of their entrance pupil varies with the variation of magnification. As the position of the back focal point of the objective is maintained, there is maximally one magnification position in which the position of the entrance pupil and the position of the back focal point coincide and the object is imaged in a telecentric mode.

On the other hand, telecentric imaging systems are known in which an objective of fixed focal length is used together with an afocal zoom system having a fixed position of its entrance pupil, which is the case with microscopes, in particular. As the magnification is varied, telecentric imaging of the object is maintained as long as the positions of entrance pupil and back focal point of the objective remain identical. Here, though, if focussing is effected by way of varying the distance between objective and zoom system, the position of the back focal point of the objective changes so that it is no longer identical with the position of the entrance pupil and, thus, telecentricity is spoiled. In this case, too, the range of possible magnifications with telecentric imaging is restricted.

DE 102004052253 A1 teaches the basic structure of variable imaging systems that are suitable especially for use on stereomicroscopes of the telescope type and comprise an objective, an afocal zoom system and a tube lens system. The said publication describes variable imaging system configurations with objectives of variable focal length and such with objectives of fixed focal length. The present invention relates to the latter.

### SUMMARY OF THE INVENTION

The problem addressed by the invention is to advance a variable imaging system incorporating an objective of fixed focal length in such a way that, as the magnification or the focus position is varied, the object-side beam path remains telecentric, thus ensuring favorable telecentric imaging of the object.

Hence, in a variable imaging system of the kind described above which include:

an objective of fixed focal length by which object situated at its front focal point is imaged at infinity,

at least one afocal zoom system as a magnification changer, and

a tube lens system that images the object from infinity to a finite distance, embodiments of the invention feature:

an afocal system of fixed magnification, arranged along the beam path between the objective and the zoom system, with the objective and the afocal system having a common back focal point that is positioned behind the afocal system on the image side and the position of which on the optical axis depends on the axial distance between the objective and the afocal system, and

means for varying this distance.

With this arrangement, an object situated at the front focal point of the objective is imaged at infinity. The afocal system arranged behind the objective further projects the image from infinity to infinity. A displacement of the afocal system along the optical axis relative to the stationary objective and the afocal zoom system results in an axial displacement of the common back focal point of the objective and the afocal system, which focal point lies behind the afocal system on the image side, the said displacement following the dynamism described by ̂L′≈L/Γ², wherein Γ is the constant magnification of the afocal system, L the measure of displacement of the afocal system, and ̂L′ the measure of position change of the common back focal point.

The objective and the afocal system are optically matched; their assembly has a fixed focal length and does not change the zoom range of the overall systems. The image produced jointly by the objective and the afocal system is situated at infinity; it is picked up by the afocal zoom system and subsequently projected into the image plane by the tube lens system. Preferably, the afocal system is designed as a Galilean telescope whose lens components are immovable relative to each other.

### BRIEF DESCRIPTION OF THE DRAWINGS

The embodiments of the present invention may be more completely understood in consideration of the following detailed description of various embodiments in connection with the accompanying drawings, in which:

FIG. 1 illustrates the principle of prior art from which the invention departs, viz., a variable imaging system with a fixed-focal-length objective and an afocal zoom system;

FIG. 2 depicts an example of a first embodiment of the invented imaging system, in which an axially displaceable afocal system of fixed magnification, a stationary zoom system with variable entrance pupil position and a fixed-focal-length tube lens system are arranged behind a stationary fixed-focal-length objective;

FIG. 3 depicts the embodiment example of the imaging system shown in FIG. 2, here illustrating the positive coupling of the axial displacements of the afocal system and the movable optical components of the afocal zoom system by means of controlled drive units and a control unit; and

FIG. 4 depicts an example of a second embodiment of the invented imaging system, in which an axially displaceable afocal system of fixed magnification, a stationary zoom system having a fixed position of its entrance pupil and a fixed-focal-length tube lens system are arranged behind an axially displaceable fixed-focal-length objective, including illustration of the positive coupling of the axial displacements of the objective, the afocal system and the movable optical components of the zoom system by means of controlled drive units and control units.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION OF THE DRAWINGS

In a first embodiment of the invention, the afocal zoom system has an entrance pupil, the position of which on the optical axis is a function of the given magnification, i.e., the position of the entrance pupil varies with the magnification. The axial displacement of the afocal system relative to the objective, taking place simultaneously with a magnification change, varies the position of the common back focal point of objective and afocal system in such a way that it remains identical to the position of the entrance pupil, thus maintaining telecentricity. The distance between objective and zoom system remains constant.

The afocal system and die movable optical components of the zoom system are connected with controlled drive units designed to effect axial displacement, and a control unit is provided permitting each drive unit to be controlled separately, in such a way that the axial displacements of the afocal system and the optical components of the zoom system are positively coupled and tuned to each other to maintain telecentricity.

In that way, the invention accomplishes that the position of the common back focal point of objective and afocal system and the position of the entrance pupil of the zoom system are identical throughout any magnification change so that it is ensured that the beam path on the object side is always telecentric.

In a second embodiment of the invention, the afocal zoom system has an entrance pupil the position of which on the optical axis is fixed, i.e., independent of the given magnification. If, in the case of such a zoom system with a fixed entrance pupil position being used in combination with the fixed-focal-length objective, the distance between objective and zoom system remains constant, the identical position of the entrance pupil and of the back focal point of the objective and thus, telecentric imaging of the object, are maintained even if the magnification is varied. If, however, one carried out a focus variation by varying the distance between objective and zoom system, the identity of the position of the entrance pupil and that of the back focal point of the objective would be abandoned and, thus, telecentricity would not be achieved.

To prevent this, the invention provides for an axially displaceable afocal system arranged behind the objective of fixed focal length, same as with the first embodiment, save that here, the axial displacement of the afocal system effects a variation not only of its distance from the objective but also of its distance from the zoom system. These distance variations are coupled to the focusing movement and ensure that, despite the focusing movement, the position of the common back focal point of the objective and the afocal system remains matched with the position of the entrance pupil of the zoom system, thus ensuring that the object-side beam path is always telecentric.

In both embodiments, the objective, the afocal system and the movable optical components of the zoom system are favorably connected with controllable drive units designed to effect axial displacement, with control units being provided for separately controlling each of these drive units. Control is affected in such a way that the axial displacements of the afocal system and the optical components of the zoom system are positively coupled and tuned to each other to maintain telecentricity.

It is within the scope of the invention to combine the objective and the afocal system into one compact objective assembly and to provide this with controlled drive units for the purpose of axial displacement of the afocal system in the first embodiment, or axial displacement of the afocal system and the objective in the second embodiment.

It is also within the inventive concept that such an objective assembly consisting of an objective and an afocal system, in which the afocal system is axially displaceable relative to the objective, can be used independently and separately from a complete imaging system of the kind described above, e.g., as a stand-alone objective, as a tube lens system the entrance pupil of which is variable in position for the purpose of matching with objectives whose back focal points are variable in position, or as a relay system.

It is further feasible for the imaging system to be provided with either one or several afocal zoom systems. The interaction of several zoom systems arranged in succession along the beam path is described, e.g., in DE 102009012707 A1, said publication being hereby fully incorporated herein by reference.

Specific afocal zoom systems featuring variable entrance pupil positions and being suitable for use in the invented variable imaging system can be found, e.g., in DE 10359733 A1, said publication being hereby fully incorporated herein by reference.

Below, the invention will be explained with reference to exemplary embodiments of a variable imaging system comprising an objective of fixed focal length, an afocal magnification changer and a fixed-focal-length tube lens system. In imaging systems of this kind, the aperture diaphragm is positioned within the afocal zoom system, and at least one of the optical components of the afocal zoom system that are movable along the optical axis is arranged between the objective and the aperture diaphragm; the fixed position of the entrance pupil is at the image of the aperture diaphragm, at a constant location in front of the zoom system.

An afocal zoom system in which the fixed position of the entrance pupil is at the image of the aperture diaphragm at a constant location in front of the zoom system, is described, e.g., in DE 102009004741 A1, said publication being hereby fully incorporated herein by reference.

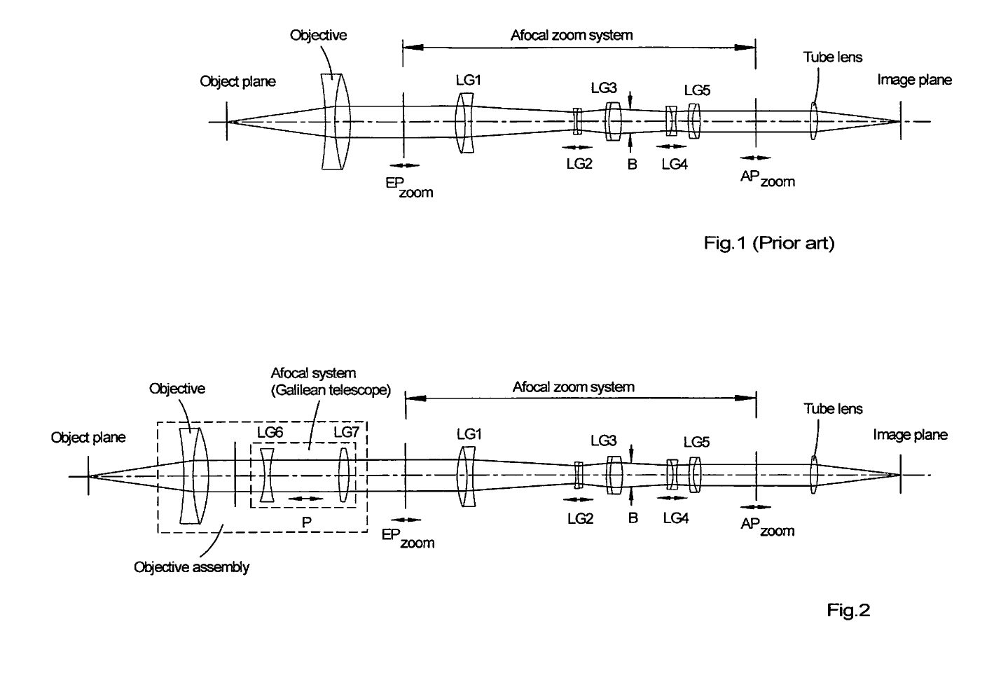

The variable imaging system shown in FIG. 1 comprises an objective of fixed focal length and imaging at infinity, an afocal zoom system for varying the magnification, and a tube lens system imaging the object from infinity onto an image plane.

With regard to telecentric imaging properties, this prior-art imaging system has the disadvantage described at the beginning, viz. that telecentric imaging is possible in one zoom position at most, namely, in the zoom position in which the variable position of the entrance pupil EP_{zoom} of the afocal zoom system coincides with the fixed position of the back focal point of the objective.

As a remedy for this disadvantage, FIG. 2, in a first embodiment of the invention, has an afocal system of fixed magnification arranged on the beam path between the objective and the afocal zoom system. The said afocal system of fixed magnification is axially displaceable relative to the objective as well as to the afocal zoom system, in the directions marked by arrows. The back focal point of objective and afocal system can be set by means of the displacement P: This displacement varies the position of the common back focal point of objective and afocal system, in such a way that, in any possible zoom position, the position of the common back focal point of objective and afocal system is identical with the position of the entrance pupil EP_{zoom} of the afocal zoom system. This permanent identity of the position of the back focal point with h position of the entrance pupil EP_{zoom} solves one of the problems of the invention, viz., the maintaining of telecentric imaging of the object while the magnification is varied.

The aperture diaphragm of such an imaging system, e.g., of a microscope, is located in the afocal zoom system, and at least one of the optical components of the afocal zoom system that are movable along the optical axis is arranged between the objective and the aperture diaphragm. As the aperture diaphragm is imaged, the exit pupil AP_{zoom} behind the afocal zoom system is brought about by the subsequent components and is normally variable, an example being shown here.

For example, the following parameters are intended for the first embodiment of the invention:
focal length of the objective 35 mm,
an afocal system in the form of a Galileian telescope of 4.6× magnification,
focal length of the negative lens component LG6 in the Galileian telescope −18.4 mm; of the positive lens component LG7, 84.8 mm,
combined focal length of the assembly of objective and Galileian telescope 160 mm, and
length of displacement of the Galileian telescope up to 16.3 mm, providing a variation of the position of the exit pupil within a range of 75 mm to 400 mm.

The afocal zoom system used is, e.g., a system specifically described in DE 10359733 A1, which has an overall length of 130 mm and comprises five optical components designed as follows, starting on the object side:
a first component LG1, stationary, of positive refracting power,
a second component LG2, movable, of negative refractive power,
a third component LG3, stationary, of positive refractive power,
a fourth component LG4, movable, of negative refractive power, and
a fifth component LG5, stationary, of positive refractive power.
   The tube lens system has a fixed focal length.

The two movable components LG2 and LG4 are movable at differing displacement speeds, the magnification set being lowest if their distance from the first component is smallest. A stationary diaphragm B positioned at the third component LG3 acts as an aperture diaphragm. It is imaged in varied positions by the neighboring variable components LG2 and LG4, with the images of the aperture diaphragm varying both at the entrance and at the exit of the afocal zoom system.

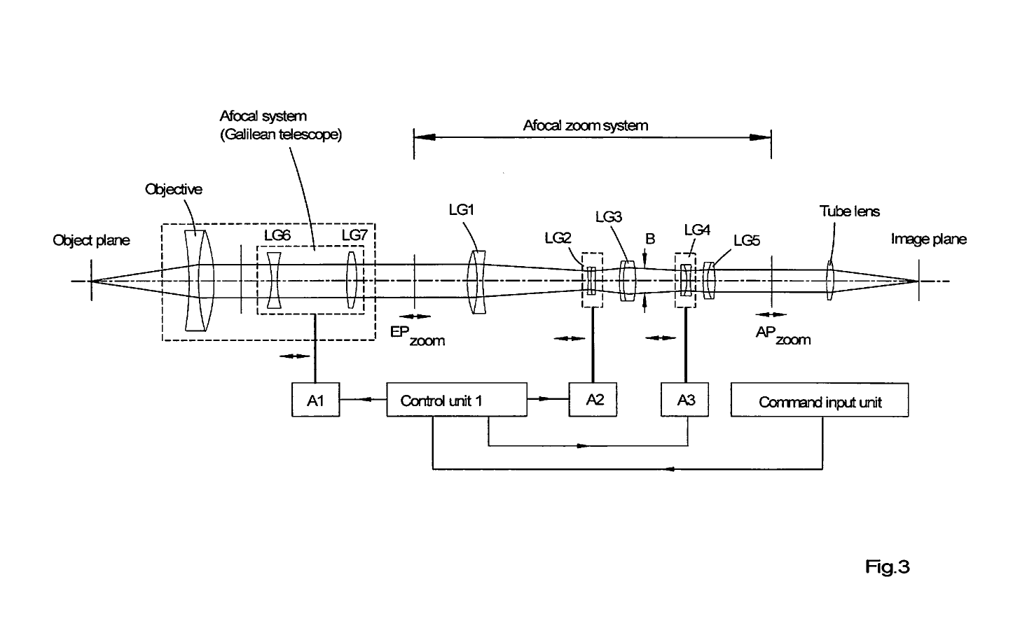

In a further development, shown in FIG. 3, of the arrangement described above, the afocal system is connected to a drive unit A1 and the two movable components LG2 and LG4 of the zoom system are connected with drive units A2 and A3 for the purpose of axial displacement. If the magnification is varied by means of the zoom system, this also changes the position of the entrance pupil EP_{zoom}. To achieve that, despite this position change, the position of the common back focal point of objective and afocal system remains always identical with the position of the entrance pupil EP_{zoom} of the zoom system, the drive units A1, A2, A3 are, by means of a control unit 1 designed to issue separate control signals to the drive units A1, A2, A3, positively coupled in such a way that coincidence of the position of the back focal point with that of the entrance pupil EP_{zoom} is always ensured although the lengths of the axial displacements of the afocal system and of the components LG2 and LG4 may differ.

The desired, available magnification is selected by means of a command input unit connected to the control unit 1.

The permanent coincidence of the position of the back focal point with that of the entrance pupil EP_{zoom} solves the problem of the invention, viz. maintaining telecentric imaging of the object while the magnification is varied.

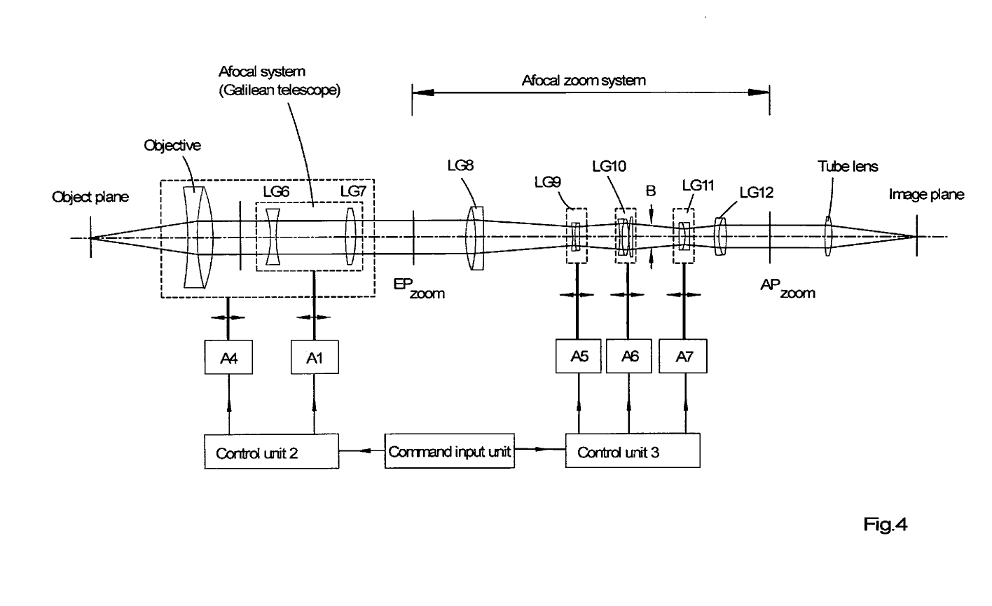

FIG. 4 shows an example of a second embodiment of the invented imaging system. The use of this embodiment of the invention is of advantage in telecentric microscopes that comprise an objective and a zoom system and in which focusing is effected by a relative movement between objective and zoom system. In prior-art microscopes of this kind, telecentric imaging of the object is possible only if the position of the back focal point of the objective is identical with the position of the entrance pupil EP_{zoom}. Accordingly, this is the case only with one particular focus setting. Under these conditions as given in prior art, a change of this focus setting will inevitably spoil telecentricity.

As a remedy for this disadvantage, as shown in FIG. 4, an axially displaceable afocal system of fixed magnification is provided on the beam path between an objective that is axially displaceable for the purpose of varying the focus setting and a stationary afocal zoom system with a fixed position of its entrance pupil EP_{zoom}. Here, the fixed entrance pupil position is at the image of the aperture diaphragm, at a constant location in front of the zoom system.

With every focusing movement of the objective, a corrective movement of the afocal system is performed in axial direction; the latter movement ensures that the position of the common back focal point of objective and afocal system always remains in the position of the entrance pupil EP_{zoom} of the zoom system, so that, for any given focus position, the object-side beam path and, thus, imaging of the object remain telecentric.

As with the first embodiment, the following parameters, for example, are intended for the objective and the afocal system of the second embodiment of the invention:
focal length of the objective 35 mm,
a afocal system in the form of a Galileian telescope of 4.6× magnification,
focal length of the negative lens component LG6 in the Galileian telescope −18.4 mm; of the positive lens component LG7, 84.8 mm,
combined focal length of the assembly of objective and Galileian telescope 160 mm, and
length of displacement of the Galileian telescope up to 16.3 mm, providing a variation of the position of the exit pupil within a range of 75 mm to 400 mm.

The afocal zoom system used is, e.g., a specific system described in DE 102009004741 A1, which has an overall length of 320 mm and comprises five optical components designed as follows, starting on the object side:
a first component LG8, stationary, of positive refractive power,
a second component LG9, movable, of negative refractive power,
a third component LG10, movable, of positive refractive power,
a fourth component LG11, movable, of negative refractive power, and
a fifth component LG12, stationary, of positive refractive power.

Here again, the tube lens system has a fixed focal length.

For the purpose of axial displacement, again the afocal system is connected to a drive unit A1, the objective is connected to a drive unit A4, and the movable components LG9, LG10 and LG11 of the zoom system are connected to drive units A5, A6 and A7, respectively. To ensure that the position of the common back focal point of objective and afocal system is always identical with the position of the entrance pupil EP_{zoom} of the zoom system, the drive units A1 and A4 are, by way of a control unit 2 designed to issue separate control signals, positively coupled in such a way that, although the axial displacements of the objective and of the afocal system may differ, coincidence of the position of the back focal point with the position of the entrance pupil EP_{zoom} is always ensured. The drive units A5, A6 and A7 are positively coupled by way of a control unit 3, which is likewise designed to issue separate control signals.

Via the command input unit, the operator triggers a focusing movement, for which a control signal is generated in the control unit 2 and issued to the drive unit A4, thus causing the axial displacement of the objective relative to the zoom system. To prevent the telecentricity to be spoiled, control unit 1 simultaneously issues a control signal to the drive unit A1, thus causing the axial displacement of the afocal system relative to the objective, by the amount needed to make the common back focal point of objective and afocal system remain in the position of the entrance pupil EP_{zoom} and thus to maintain telecentricity.

The permanent coincidence of the position of the back focal point with that of the entrance pupil EP_{zoom} solves the problem of the invention, viz. maintaining telecentric imaging of the object while the focus position is varied.

In the imaging systems according to FIG. 3 and FIG. 4, only one beam path is shown, whereas the scope of the invention expressly includes configurations in which the objective is a common main objective of two beam paths of a stereomicroscope of the telescope type. This also applies to further applications of the invented arrangement, especially such configurations in which the objective, the afocal system and the drive means coupled with the afocal system are combined to form a stand-alone objective assembly.

However, the range of applications of the invented arrangement is expressly understood not to be restricted to imaging systems but to extend generally to optical systems in which tube lens systems of both fixed and variable focal length are employed.

What is claimed is:

1. A variable imaging system, comprising:
an objective of fixed focal length which images an object positioned at its front focal point to infinity;
at least one afocal zoom system as a magnification changer;
a tube lens system which images the object from infinity to a finite distance; and
an afocal system of fixed magnification arranged on a beam path between the objective and the afocal zoom system, the objective and the afocal system having a common back focal point located behind the afocal system on the image side, the position of the afocal system on an optical axis being a function of an axial distance between the objective and the afocal system, the system including means for varying the axial distance.

2. The variable imaging system of claim 1, in which the afocal zoom system has an entrance pupil, the position of the entrance pupil on the optical axis being a function of a preselected magnification, and wherein a distance between the objective and the afocal system is selectively variable while the distance between the objective and the zoom system remains constant.

3. The variable imaging system of claim 2, in which the afocal zoom system has an overall length of 130 mm and comprises five optical components in order, starting on the object side:
a stationary first component (LG1) of positive refractive power;
a movable second component (LG2) of negative refractive power;
a stationary third component (LG3) of positive refractive power;
a movable fourth component (LG4) of negative refractive power; and
a stationary fifth component (LG5) of positive refractive power, and wherein the system further includes an aperture diaphragm in a stationary position at the third component (LG3).

4. The variable imaging system of claim 3, further comprising:
a first drive unit (A1) arranged to axially displace the afocal system;
a second drive unit (A2) arranged to axially displace the second component (LG2);
a third drive unit (A3) arranged to axially displace the fourth component (LG4); and
a control unit communicatively connected to the first drive unit, the second drive unit, and the third drive unit, wherein the axial displacements of the afocal system, the second component, and the fourth component are selectively adjustable with the control unit, and wherein the control unit ensures that the back focal point coincides with the entrance pupil.

5. The variable imaging system of claim 1, wherein the afocal zoom system has an entrance pupil, the position of the entrance pupil on the optical axis being fixed and not variable with magnification changes, and wherein the distance between the objective and the afocal system, and the distance between the objective and the afocal zoom system are selectively variable.

6. The variable imaging system of claim 5, in which the afocal zoom system has an overall length of 320 mm and comprises five optical components as follows, starting on the object side:
a stationary first component (LG8) of positive refractive power;
a movable second component (LG9) of negative refractive power;
a movable third component (LG10) of positive refractive power;
a movable fourth component (LG11) of negative refractive power; and
a stationary fifth component (LG12) of positive refractive power.

7. The variable imaging system of claim 6, further comprising a first drive unit arranged to axially displace the afocal system, a second drive unit arranged to axially displace the objective including the afocal system, and drive units (A5, A6, A7) for the axial displacement of the movable components (LG9, LG10, LG11) of the zoom system are provided, and
the drive units (A1, A4) are connected to a control unit 2 and the drive units (A5, A6, A7) are connected to a control unit 3, by means of which the axial displacements of the objective, of the afocal system and of the components (LG9, LG11) are positively coupled.

8. The variable imaging system of claim 1, wherein the afocal system is a Galileian telescope comprising two lens components, the relative position of which is invariable.

9. The variable imaging system of claim 1, wherein:
the focal length of the objective is 35 mm;
the afocal system is a Galileian telescope of 4.6× magnification, wherein the focal length of a negative lens component in the Galileian telescope is −18.4 mm, and wherein the focal length of a positive lens component is 84.8 mm;
the objective assembly has a combined focal length of 160 mm; and
the displacement of the Galileian telescope by 16.3 mm effects a variation of the position of the exit pupil within a range of 75 mm to 400 mm.

10. The variable imaging system of claim 1, further comprising a plurality of afocal zoom systems.

11. A variable imaging system, comprising:
an objective of fixed focal length which images an object positioned at its front focal point to infinity;
at least one afocal zoom system;
a tube lens system which images the object from infinity to a finite distance; and
an afocal system of fixed magnification arranged on a beam path between the objective and the afocal zoom system, the objective and the afocal system having a common back focal point located behind the afocal system on the image side, the position of the afocal system on an optical axis being a function of an axial distance between the objective and the afocal system, the system including at least one drive unit operably coupled to the afocal system and arranged to selectively vary the axial distance.
